(19) United States
(12) Patent Application Publication
(10) Pub. No.: US 2004/0109599 A1
(43) Pub. Date: Jun. 10, 2004

(54) Method for locating the center of a fiducial mark

(76) Inventors: Seong Ik Cho, Daejeon (KR); Ki In Bang, Iksan-si (KR); Ji Hun Seo, Pyeongchang-gun (KR); Kyung Ok Kim, Daejeon (KR); Jong-Hun Lee, Seoul (KR)

Correspondence Address: JACOBSON HOLMAN PLLC, 400 SEVENTH STREET N.W., SUITE 600, WASHINGTON, DC, 20004, US

(21) Appl. No.: 10/435,193

(22) Filed: May 12, 2003

(30) Foreign Application Priority Data
Dec. 10, 2002 (KR) 10-2002-0078426

(51) Int. Cl. G06K 9/00

(52) U.S. Cl. 382/145

(57) ABSTRACT

In a method for locating the center of a fiducial mark contained in an image, a certain region covering every fiducial mark in the image is defined. A region containing each fiducial mark within the certain region is extracted. The center of the fiducial mark within the region containing each fiducial mark is located to pixel accuracy. The center of the fiducial mark within the region containing each fiducial mark is located to sub-pixel accuracy according to the pixel level locating of the center of the fiducial mark.

### FIELD OF THE INVENTION

The present invention relates to a method for locating the center of a fiducial mark; and, more particularly, to a method for finding the center of a fiducial mark corresponding to an image pattern of a printed circuit board (PCB) or an aerial photograph image.

### BACKGROUND OF THE INVENTION

In general, a fiducial mark is used for setting a reference point when certain chips are mounted on a printed circuit board (PCB). In other words, fiducial marks are searched during a process for mounting the certain chips on the PCB, and then, locations of the chips are accurately determined based on relative positions of the fiducial marks.

A fiducial mark search process involves inputting a PCB image taken by a camera into a computer, defining a region which seems to have a fiducial mark as a region of interest, setting a template pattern identical to a shape of the fiducial mark and matching the template pattern with the shape of the fiducial mark by comparing from a left top to a right bottom within the region of interest to thereby find the center of a best-matched location as a center of the fiducial mark.

However, such process requires preliminary information on an accurate template pattern and also takes considerable time to automatically find the center of a fiducial mark. Furthermore, in the event that a part of an input image of the fiducial mark is damaged, an accurate center of the fiducial mark cannot be obtained.

### SUMMARY OF THE INVENTION

It is, therefore, an object of the present invention to provide a method for locating the center of a fiducial mark, wherein the method involves defining a certain region covering a fiducial mark that is an image pattern on a printed circuit board or an aerial photograph image, determining a top and a bottom region containing the fiducial mark, finding a horizontal and a vertical symmetry within the determined region, locating the center of the fiducial mark to a pixel accuracy and locating the center of the fiducial mark to a sub-pixel accuracy by using information on the pixel level location of the fiducial mark.

In accordance with an aspect of the present invention, there is provided a method for locating the center of a fiducial mark on an image, including the steps of: (a) defining a certain region covering every fiducial mark on the image; (b) segmenting a region covering each fiducial mark within the certain region; (c) locating the center of the fiducial mark within the region covering each fiducial mark to a pixel accuracy; and (d) locating the center of the fiducial mark within the region covering each fiducial mark to a sub-pixel accuracy based on the center of the fiducial mark located by step (c).

In accordance with another aspect of the present invention, there is provided a recording medium for recording a program for implementing a method for locating the center of a fiducial mark.

### BRIEF DESCRIPTION OF THE DRAWINGS

The above and other objects and features of the present invention will become apparent from the following description of preferred embodiments, given in conjunction with the accompanying drawings, in which:

FIG. 1 shows a block diagram for locating of the center of a fiducial mark in accordance with the present invention;

FIG. 2 describes a diagram for illustrating general locations and shapes of the fiducial marks in a printed circuit board or an aerial photograph image in accordance with the present invention;

FIGS. 3A and 3B depict diagrams for showing geometric models of the fiducial marks located in a corner and an edge-center of the certain region, respectively, in accordance with the present invention;

FIG. 4 provides a detailed drawing of a pixel center locating unit shown in FIG. 1;

FIGS. 5A and 5B present diagrams for illustrating steps for defining a range of fiducial marks located in a corner and an edge-center, respectively, in accordance with the present invention;

FIG. 6 represents a flowchart for explaining a locating of the edge-center of a fiducial mark in an image processing in accordance with the present invention;

FIGS. 7A to 7C offer diagrams for describing convolution kernels used in the image processing in accordance with the present invention; and

FIG. 8 sets forth a detailed diagram of a sub-pixel center locating unit shown in FIG. 1.

### DETAILED DESCRIPTION OF THE PREFERRED EMBODIMENTS

Hereinafter, preferred embodiments of the present invention will be described in detail with reference to the accompanying drawing.

FIG. 1 shows a block diagram for locating the center of a fiducial mark in accordance with the present invention. An apparatus for locating the center of the fiducial mark includes a target region defining unit 100, a mark region segmenting unit 200, a pixel center locating unit 300 and a sub-pixel center locating unit 400.

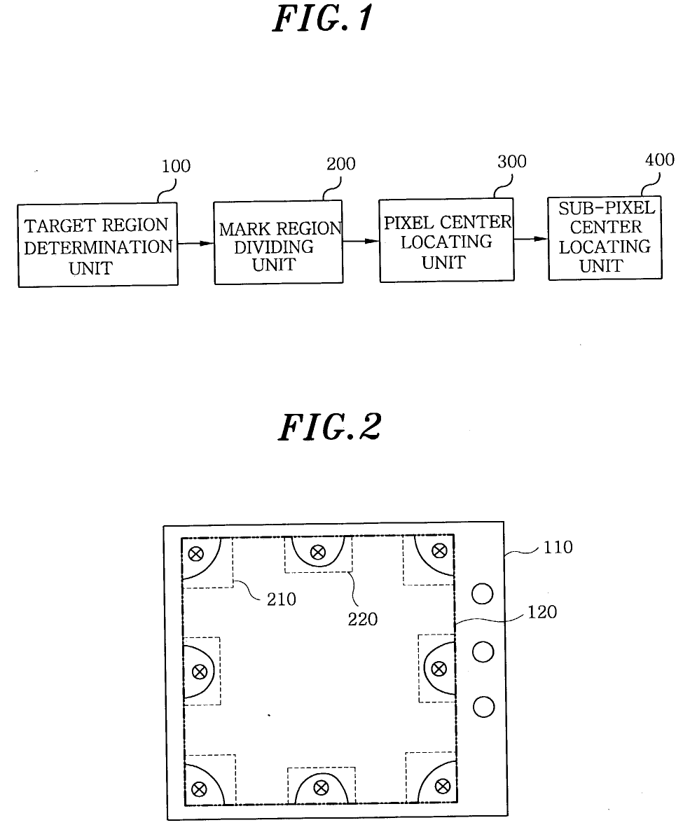

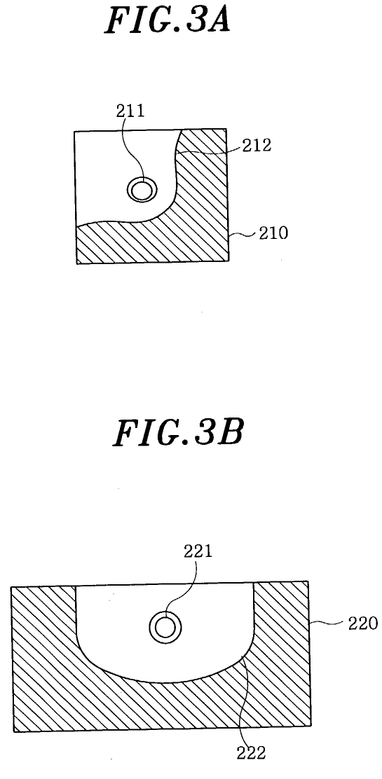

As illustrated in FIG. 2, the target region defining unit 100 determines a square region 120 covering every fiducial mark in four corners or edge-centers or other determined locations on a printed circuit board or an aerial photograph image 110.

The mark region segmenting unit 200 separates a corner region 210 covering a fiducial mark therein from the square region 120 or a edge-center region 220 having a fiducial mark therein from the square region 120. That is to say, the mark region segmenting unit 200 extracts and defines every region covering fiducial marks contained in the inputted image 110.

As shown in FIG. 3A, a geometric model of the corner region 210 has a requirement that a fiducial mark 211 is assumed to be on a geometric center of a uniformly luminous region 212. And further, the fiducial mark 211 is formed by geometric elements such as a straight line, a circle, a point and the like, and is horizontally/vertically symmetric and rotationally symmetric from the view of the center of the fiducial mark 211. Furthermore, the uniformly luminous region 212 of the geometric model is diagonally symmetric to the center of the fiducial mark 211.

And also, as illustrated in FIG. 3B, a geometric model of the center region 220 has a requirement that a fiducial mark 221 is assumed to be on a geometric center of a uniformly luminous region 222. And further, the fiducial mark 221 is horizontally/vertically symmetric and rotationally symmetric. Furthermore, the uniformly luminous region 222 of the geometric model is horizontally symmetric to the center of the fiducial mark 221.

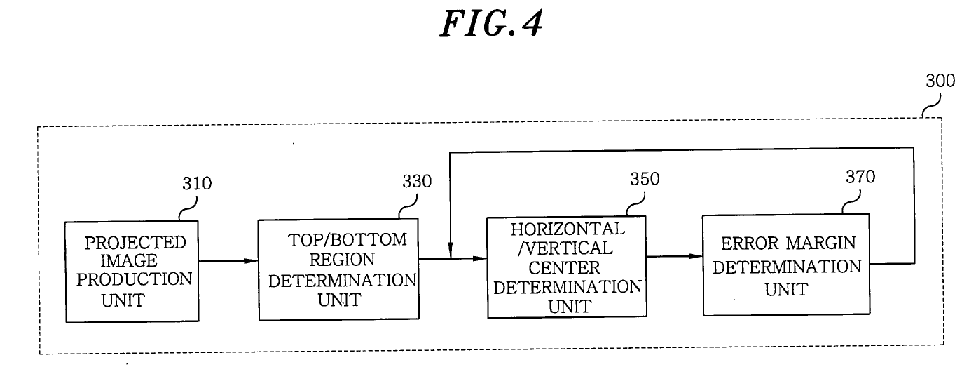

The pixel center locating unit 300 includes a projected image production unit 310, a top/bottom region determination unit 330, a horizontal/vertical center determination unit 350 and an error margin determination unit 360 as illustrated in FIG. 4.

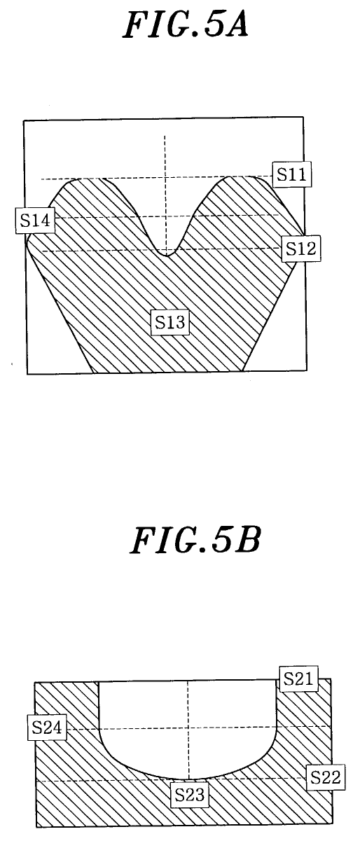

The projected image production unit 310 is only applied when a projection of the corner region 210 is performed, wherein the corner region 210 is projected to have a shape as illustrated in FIG. 5A.

The top/bottom region determination unit 330 determines a range of a top region S11 and then that of a bottom region S12 shown in FIG. 5A in the projected corner region 210 if the projected corner region 210 has the fiducial mark therein.

Further, the top/bottom region determination unit 330 determines a range of a top region S21 and then that of a bottom region S22 illustrated in FIG. 5B in the edge-center region 220 if the edge-center region 220 has the fiducial mark therein.

For the corner region, the horizontal/vertical center determination unit 350 determines a horizontal centerline S13 and then a vertical centerline S14 as shown in FIG. 5A, wherein the horizontal centerline S13 is determined based on a horizontal symmetry.

Further, for the edge-center region, the horizontal/vertical center determination unit 350 determines a horizontal centerline S23 and then a vertical centerline S24 as illustrated in FIG. 5B. At this time, the horizontal centerline S23 is determined based on a horizontal symmetry.

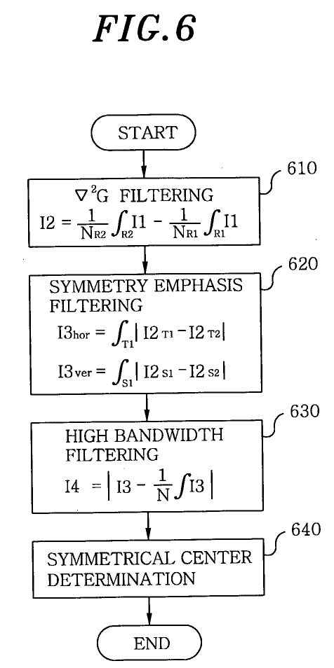

As described in FIG. 6, the horizontal/vertical center determination unit 350 undergoes a ∇²G (Laplacian of Gaussian) filtering 610, a symmetry enhancement filtering 620, a high bandwidth filtering 630 and a symmetrical center determination processing 640 to determine a horizontal/vertical center.

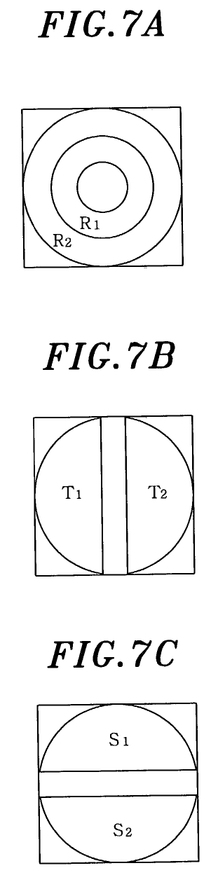

Specifically, the ∇²G filtering 610 is performed for enhancing an eccentricity of the images. Referring to FIG. 7A, the ∇²G filtering 610 is performed on regions R1 and R2 defined by a ∇²G convolution kernel. An output of the ∇²G filtering 610 is obtained by using a following Eq. (1).

$$I2 = \frac{1}{{N}_{R2}} {\int }_{R2}^{} I1 - \frac{1}{{N}_{R1}} {\int }_{R1}^{} I1 \qquad Eq . ( 1 )$$

Herein, N_{R1}, N_{R2}, I1 and I2 indicate the number of pixels in the region R1, the number of pixels in the region R2, an input image and a ∇²G filtered image, respectively.

The symmetry enhancement filtering 620 enhances a horizontal and a vertical symmetric feature of the ∇²G filtered image. Referring to FIG. 7B, the horizontal symmetry enhancement filtering is performed on regions T1 and T2 defined by a horizontal symmetry kernel. An output of the horizontal symmetry enhancement filtering is obtained by using an Eq. (2).

I3ₕₒᵣ=∫_{T1}|I2_{T1}−I2_{T2}| Eq. (2)

Herein, I2_{T1}, I2_{T2}, I2 and I3ₕₒᵣ represent the number of pixels in the region T1, the number of pixels in the region T2, an input image and a horizontal symmetry enhancement filtered image, respectively.

Meanwhile, referring to FIG. 7B, the vertical symmetry enhancement filtering is performed on regions S1 and S1 defined by a vertical symmetry kernel. An output of the vertical symmetry enhancement filtering is obtained by using an Eq. (3).

I3ᵥₑᵣ=∫_{S1}|I2_{S1}−I2_{S2}| Eq. (3)

Herein, I2_{S1}, I2_{S2}, I2 and I3ᵥₑᵣ indicate the number of pixels in the region S1, the number of pixels in the region S2, an input image and a vertical symmetry enhancement filtered image, respectively.

The high bandwidth filtering 630 is performed on the symmetry enhancement filtered image to find a location featuring the highest symmetry. An absolute value of a difference between an original image and a smoothed image is calculated by using an Eq. (4).

$$I4 = \vert I3 - \frac{1}{N} \int I3 \vert \qquad Eq . ( 4 )$$

Herein, N, I3 and I4 represent the number of pixels in a region to be smoothed, an input image and a high bandwidth filtered image, respectively.

The symmetrical center determination 640 involves searching a location having a largest pixel value according to a result of the high bandwidth filtering and determining the searched location to be the center of a fiducial mark.

The error margin determination unit 370 iteratively locates horizontal centerlines S13 and S23 by using vertical centerlines S14 and S24 shown in FIGS. 5A and 5B thus increasing accuracy of the central position. At this time, if an error of the vertical and the horizontal centers due to iterative locating is within a determined error margin, the iterative locating is discontinued and a center of the fiducial mark at pixel level is determined.

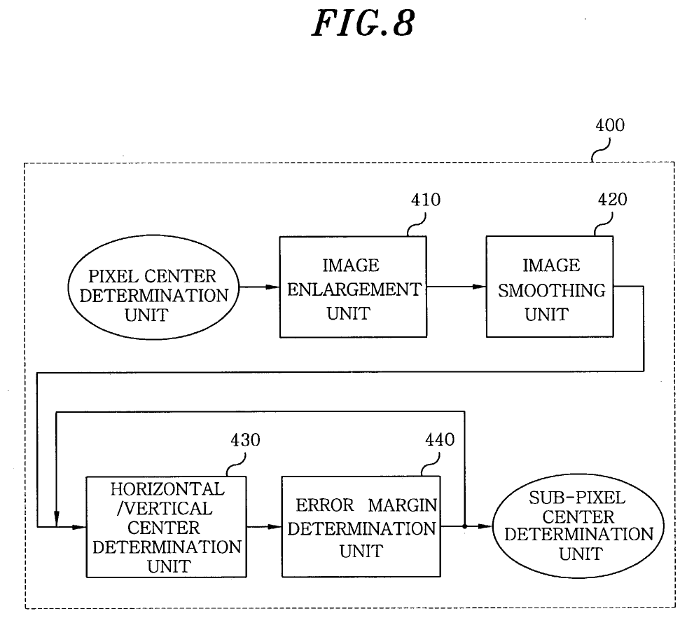

Referring to FIG. 8, a sub-pixel center locating unit 400 includes an image enlargement unit 410, an image smoothing unit 420, a horizontal/vertical center determination unit 430 and an error margin determination unit 440, wherein the horizontal/vertical center determination unit 430 iteratively locates a horizontal/vertical center until an error of the horizontal/vertical center is within a determined error margin.

The image enlargement unit 410 enlarges images of the center of the fiducial mark located by the pixel center locating unit 300 and those of the predetermined peripheral regions by using an interpolation technique, and therefore, the images with a sub-pixel accuracy are obtained.

The image smoothing unit 420 smoothes the enlarged images to soften a spatial luminosity distribution of the images.

The horizontal/vertical center determination unit 430 is performed on the image to sub-pixel accuracy through the horizontal/vertical center determination unit 350 as illustrated in FIG. 4. In this case, the horizontal/vertical center determination unit 430 for a sub-pixel level undergoes the same processes used in the horizontal/vertical center determination unit 350 for a pixel level.

The error margin calculation unit 440 iteratively performs the horizontal/vertical center determination to the sub-pixel accuracy, which is performed in the horizontal/vertical center determination unit 430 at sub-pixel level to achieve a higher resolution. At this time, if an error of the vertical and the horizontal center caused by the iterative locating is within a determined error margin, the iterative locating is discontinued and a center of the fiducial mark to sub-pixel level is determined.

Subsequently, based on each center obtained by the pixel center locating unit 300 and the sub-pixel center location unit 400, it is possible to accurately locate the center of a fiducial mark on an image of a printed circuit board or an aerial photograph image with sub-pixel accuracy.

As described above, since the present invention does not use information on a standard pattern indicating an accurate pattern of a mark or a geometric model, it is possible to automatically locate the center of a fiducial mark without using any information on the accurate standard pattern of the mark.

While the invention has been shown and described with respect to the preferred embodiments, it will be understood by those skilled in the art that various changes and modifications may be made without departing from the spirit and scope of the invention as defined in the following claims.

What is claimed is:

1. A method for calculating the center of a fiducial mark contained in an image, comprising the steps of:
(a) defining a certain region covering every fiducial mark in the image;
(b) segmenting a region covering each fiducial mark within the certain region;
(c) locating the center of the fiducial mark within the region covering each fiducial mark to pixel accuracy; and
(d) locating the center of the fiducial mark within the region covering each fiducial mark to sub-pixel accuracy based on the center of the fiducial mark located by step (c)

2. The method of claim 1, wherein the region covering each fiducial mark is a corner region containing a fiducial mark in the corner of the certain region or a center region covering a fiducial mark in the center of the certain region.

3. The method of claim 1, wherein each fiducial mark is on a geometric center of a uniformly luminous region among the certain region.

4. The method of claim 1, wherein the fiducial mark is composed of a straight line, a circle, a point and the like, and is symmetric horizontally/vertically and rotationally.

5. The method of claim 2, wherein the fiducial mark in the corner region is located in a uniformly luminous region that is symmetric diagonally.

6. The method of claim 2, wherein the fiducial mark in the center region is located in a uniformly luminous region that is symmetric horizontally.

7. The method of claim 1, wherein the steps (c) and (d) iteratively is performed for locating a horizontal and a vertical center based on symmetry of the uniformly luminous region in order to increase accuracy of the location of the center of the fiducial mark.

8. The method of claim 7, wherein the step (d) involves enlarging the certain region containing the fiducial mark through an interpolation, performing a smoothing process and applying iterative center locating to the enlarged image.

9. The method of claim 1, wherein the step (c) involves sequentially applying a ∇²G (Laplacian of Gaussian) filtering, a symmetry enhancement filtering and a high bandwidth filtering to an image of a fiducial mark being symmetric horizontally/vertically to the center of the fiducial mark and locating the center of the symmetry thereby determining the center of the fiducial mark.

10. A recording medium for recording a program for implementing a method of claim 1 for locating the center of a fiducial mark.
